(19) United States
(12) Patent Application Publication
(10) Pub. No.: US 2026/0269877 A1
(43) Pub. Date: Sep. 10, 2026

(54) MULTI-ACCESS POINT COORDINATED BEAMFORMING IN WIRELESS COMMUNICATIONS

(71) Applicant: MEDIATEK INC., Hsinchu City (TW)

(72) Inventors: Yongho SEOK, San Jose, CA (US); Jianhan LIU, San Jose, CA (US); Weisung TSAO, San Jose, CA (US); Gary A. ANWYL, San Jose, CA (US); James Chih-Shi YEE, San Jose, CA (US)

(21) Appl. No.: 19/167,699

(22) PCT Filed: Jul. 3, 2024
(86) PCT No.: PCT/CN2024/103252

§ 371 Date: Sep. 22, 2025

Related U.S. Application Data
(60) Provisional application No. 63/524,725, filed on Jul. 3, 2023.

(51) Int. Cl. H04B 7/0408; H04B 7/024; H04B 7/06; H04W 72/044

(52) U.S. Cl. CPC H04B 7/0408; H04B 7/024; H04B 7/0617; H04W 72/046

(57) ABSTRACT

Various schemes pertaining to multi-access point (multi-AP) coordinated beamforming in wireless communications are described. An apparatus (e.g., a sharing access point (AP)) triggers a shared AP of a multi-AP system to participate in a coordinated beamforming transmission. The apparatus then transmits a first coordinated beamformed physical-layer protocol data unit (PPDU) which is aligned in time with a second coordinated beamformed PPDU transmitted by the shared AP.

### CROSS REFERENCE TO RELATED PATENT APPLICATION

The present disclosure is part of a non-provisional patent application claiming the priority benefit of U.S. Provisional Patent Application No. 63/524,725, filed 3 Jul. 2023, the content of which being incorporated by reference in its entirety.

### TECHNICAL FIELD

The present disclosure is generally related to wireless communications and, more particularly, to multi-access point (multi-AP) coordinated beamforming in wireless communications.

### BACKGROUND

Unless otherwise indicated herein, approaches described in this section are not prior art to the claims listed below and are not admitted as prior art by inclusion in this section.

In wireless communications, such as Wi-Fi (or WiFi) and wireless local area networks (WLANs) in accordance with one or more Institute of Electrical and Electronics Engineers (IEEE) 802.11 standards (e.g., IEEE 802.11be), a joint null data packet (NDP) sounding scheme is provided as an optional mode for multi-AP systems. Sequential sounding schemes in which each access point (AP) transmits an NDP independently and sequentially without overlapped sounding period of each AP can also be used in multi-AP systems. The joint NDP sounding scheme for multi-AP systems with less or equal to a total of 8 antennas at each AP has all antennas active on all long-training field (LTF) tones and uses IEEE 802.11ax P matrix across orthogonal frequency-division multiplexing (OFDM) symbols. Multiple APs can sequentially use an IEEE 802.11ax-like sounding sequence to collect channel state information (CSI) from in-basic service set (in-BSS) stations (STAs) and overlapping-basic service set (OBSS) STAs. The sounding sequence of each AP is similar to the IEEE 802.11ax sounding protocol with multiple STAs (e.g., NDP announcement (NDPA)+NDP+beamforming report poll (BFRP) trigger frame (TF)+CSI report). In sequential channel sounding sequence for multi-APs, the NDPA frame and BFRP TF frame include identity (ID) information for OBSS STA(s).

In a sequential channel sounding sequence for multi-AP systems, IEEE 802.11be supports certain features. For instance, a STA can process the NDPA frame and the BFRP TF received from an OBSS AP, which belongs to a multi-AP set serving the STA. Additionally, if polled by the BFRP TF from the OBSS AP, the STA responds with its corresponding CSI to the OBSS AP. In a scenario in which the IEEE 802.11ax sounding sequence is reused in a multi-AP system, STA₁₁to STA_{1N} may be associated with AP₁, and STA₂₁ to STA_{2N} may be associated with AP₂. AP₁ may first transmit NDPA₁ followed by NDP₁ and a BFRP TF; and in response, each of STA₁₁ to STA_{1N} may a corresponding CSI report to AP₁. Then, AP₂ may first transmit NDPA₂ followed by NDP₂ and a BFRP TF; and in response, each of STA₂₁ to STA_{2N} may a corresponding CSI report to AP₂. However, for ultra-high reliability (UHR) communications, the above-described scenario tends to be less efficient than desirable, thereby resulting in less-than-ideal system performance. Therefore, there is a need for a solution of multi-AP coordinated beamforming in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to multi-AP coordinated beamforming in wireless communications. It is believed that implementations of the proposed schemes may address or otherwise alleviate aforementioned issues. For instance, system performance may be improved through implementations of the multi-AP coordinated beamforming under the proposed schemes.

In one aspect, a method may involve a sharing AP triggering a shared AP of a multi-AP system to participate in a coordinated beamforming transmission. The method may also involve the sharing AP transmitting a first coordinated beamformed physical-layer protocol data unit (PPDU) which is aligned in time with a second coordinated beamformed PPDU transmitted by the shared AP.

In one aspect, a method may involve a shared AP receiving a trigger from a sharing AP of a multi-AP system that triggering the shared AP to participate in a coordinated beamforming transmission. The method may also involve the shared AP, responsive to receiving the trigger, transmitting a second coordinated beamformed PPDU which is aligned in time with a first coordinated beamformed PPDU transmitted by the sharing AP.

It is noteworthy that, although description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies such as, for example and without limitation, Bluetooth, ZigBee, 5^{th} Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example scenario under a proposed scheme in accordance with the present disclosure.

FIG. 3 is a diagram of an example scenario under a proposed scheme in accordance with the present disclosure.

FIG. 4 is a diagram of an example scenario under a proposed scheme in accordance with the present disclosure.

FIG. 5 is a diagram of an example scenario under a proposed scheme in accordance with the present disclosure.

FIG. 6 is a diagram of an example scenario under a proposed scheme in accordance with the present disclosure.

FIG. 7 is a diagram of an example scenario under a proposed scheme in accordance with the present disclosure.

FIG. 8 is a block diagram of an example communication system under a proposed scheme in accordance with the present disclosure.

FIG. 9 is a flowchart of an example process under a proposed scheme in accordance with the present disclosure.

FIG. 10 is a flowchart of an example process under a proposed scheme in accordance with the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to multi-AP coordinated beamforming in wireless communications. According to the present disclosure, a number of possible solutions may be implemented separately or jointly. That is, although these possible solutions may be described below separately, two or more of these possible solutions may be implemented in one combination or another.

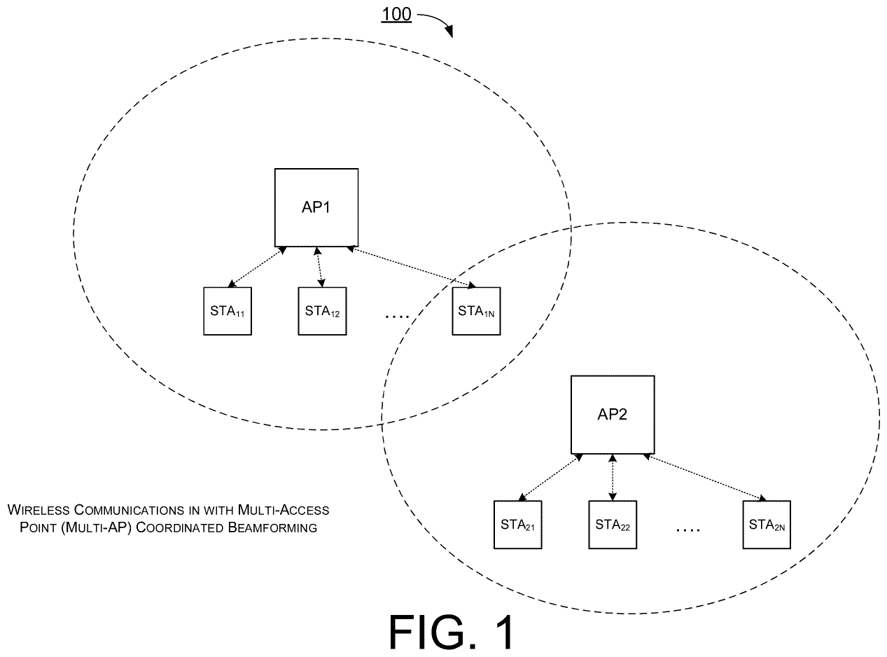

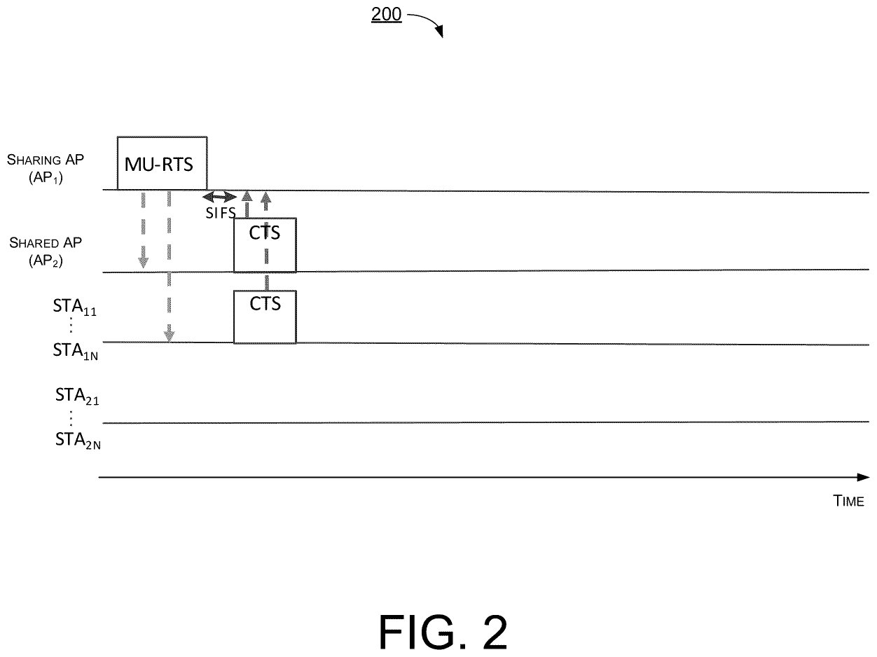

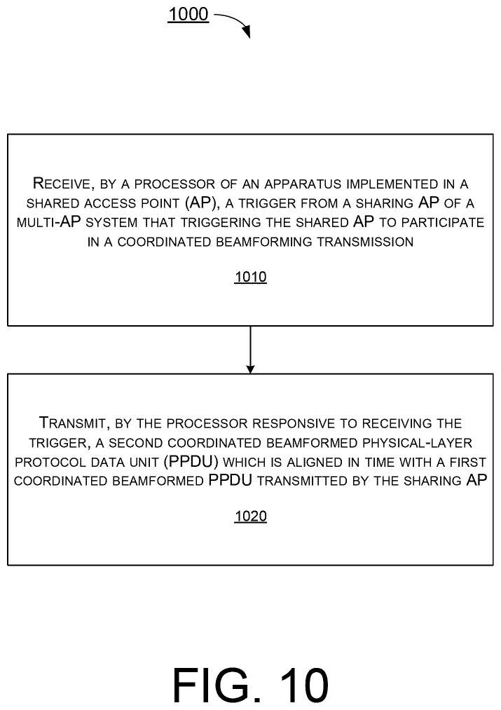

FIG. 1 illustrates an example network environment 100 in which various solutions and schemes in accordance with the present disclosure may be implemented. FIG. 2~FIG. 10 illustrate examples of implementation of various proposed schemes in network environment 100 in accordance with the present disclosure. The following description of various proposed schemes is provided with reference to FIG. 1~FIG. 10.

Referring to FIG. 1, network environment 100 may involve a multi-AP system with at least a first AP (e.g., AP₁), with its associated STAs (STA₁₁~STA_{1N}), and a second AP (AP₂), with its associated STAs (STA₂₁~STA_{2N}). Each of AP₁ and AP₂, as well as their associated STAs, may be configured to communicate with each other by utilizing the multi-AP coordinated beamforming in accordance with various proposed schemes described below. For instance, under the various proposed schemes described herein, AP₁ may function as a master AP (herein interchangeably referred to as a “sharing AP”) and AP₂ may function as a slave AP (herein interchangeably referred to as a “shared AP”), and vice versa. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

FIG. 2 illustrates an example scenario 200 under a proposed scheme of multi-AP coordinated beamforming in accordance with the present disclosure. Under the proposed scheme, a sharing AP (e.g., AP₁) may transmit a first control frame (e.g., multi-user request-to-send (MU-RTS)) to a shared AP (e.g., AP₂) as well as the STAs associated with the sharing AP (e.g., STA₁₁~STA_{1N}). The MU-RTS frame may include information of the shared AP. In response, each of the shared AP and sharing AP's associated STAs may transmit a corresponding response frame (e.g., clear-to-send (CTS)) to the sharing AP.

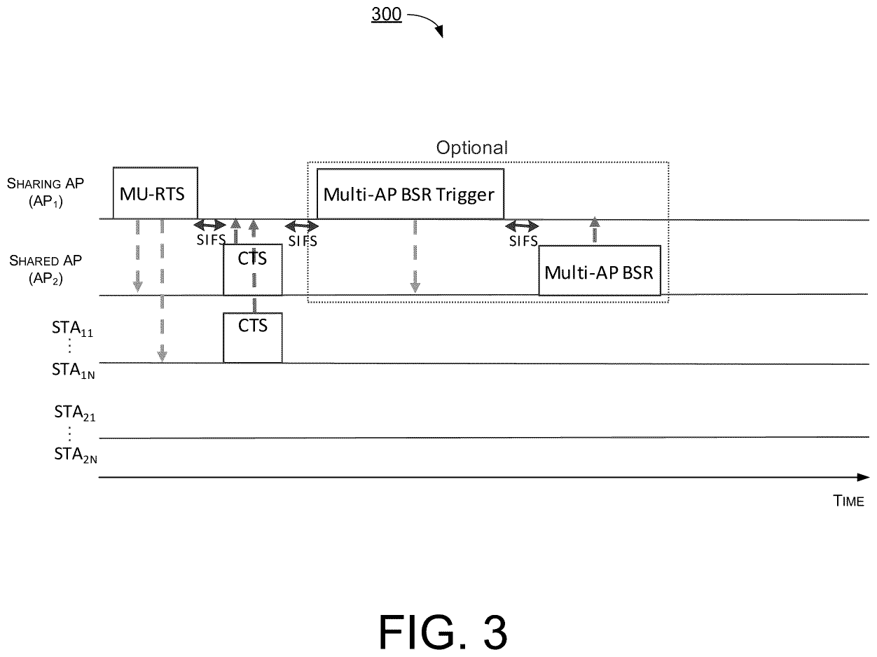

FIG. 3 illustrates an example scenario 300 under a proposed scheme of multi-AP coordinated beamforming in accordance with the present disclosure. Under the proposed scheme, after the frame exchange described above with respect to FIG. 2, the sharing AP (e.g., AP₁) may transmit a second control frame (e.g., multi-AP buffer status report (BSR) trigger frame) to each of one or more shared AP (e.g., AP₂). In response, each of the one or more shared APs may provide a respective list of candidate STA(s) among its associated STAs (e.g., STA₂₁~STA_{2N} for AP₂).

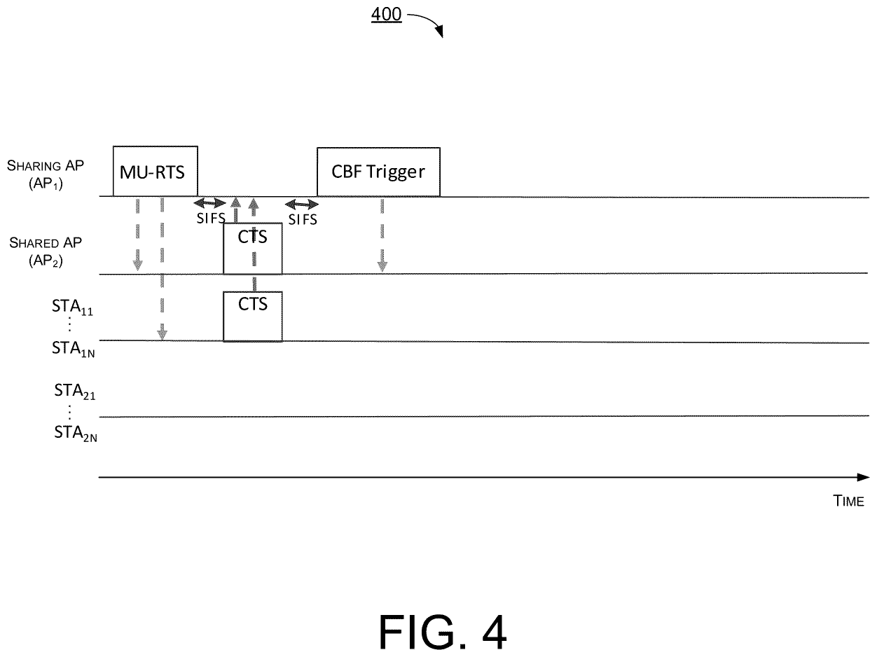

FIG. 4 illustrates an example scenario 400 under a proposed scheme of multi-AP coordinated beamforming in accordance with the present disclosure. Under the proposed scheme, after the frame exchange described above with respect to FIG. 2, the sharing AP (e.g., AP₁) may transmit a second control frame (e.g., coordinated beamforming (CBF) trigger frame) to the shared AP (e.g., AP₂). The CBF trigger frame may indicate that the shared AP may transmit a coordinated beamformed physical-layer protocol data unit (PPDU) a short interframe space (SIFS) after the second control frame. The second control frame may contain information of the shared AP, as well as downlink (DL) and uplink (UL) transmission times, and so on.

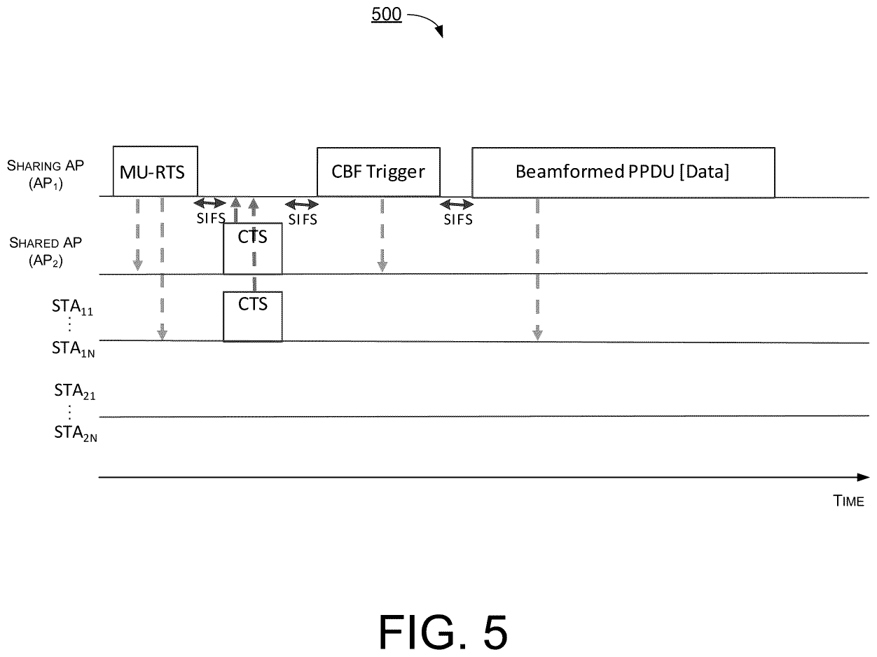

FIG. 5 illustrates an example scenario 500 under a proposed scheme of multi-AP coordinated beamforming in accordance with the present disclosure. Under the proposed scheme, after the frame exchange described above with respect to FIG. 4, the sharing AP (e.g., AP₁) may transmit a coordinated beamformed PPDU carrying a data frame to its associated STAs, STA₁₁~STA_{1N}.

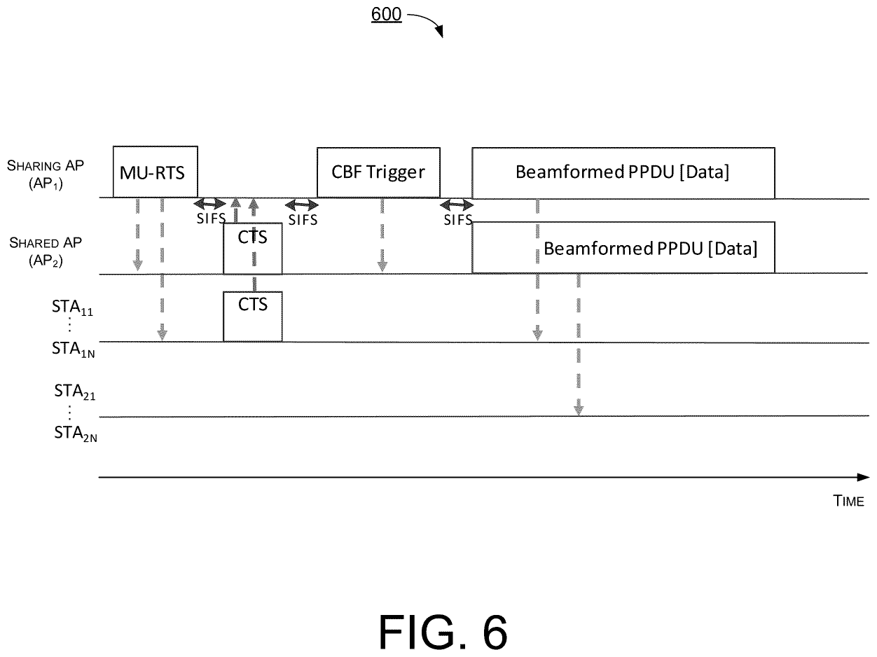

FIG. 6 illustrates an example scenario 600 under a proposed scheme of multi-AP coordinated beamforming in accordance with the present disclosure. Under the proposed scheme, after the frame exchange described above with respect to FIG. 5, the shared AP (e.g., AP₂), which is indicated in the second control frame, may transmit a coordinated beamformed PPDU carrying a data frame to its associated STAs, STA₂₁~STA_{2N}. The shared AP may need to perform channel sensing (CS) to ensure that the channel is idle before transmitting its coordinated beamformed PPDU. The coordinated beamformed PPDU transmitted by the sharing AP and the coordinated beamformed PPDU transmitted by the shared AP may be aligned in the time domain, as shown in FIG. 6.

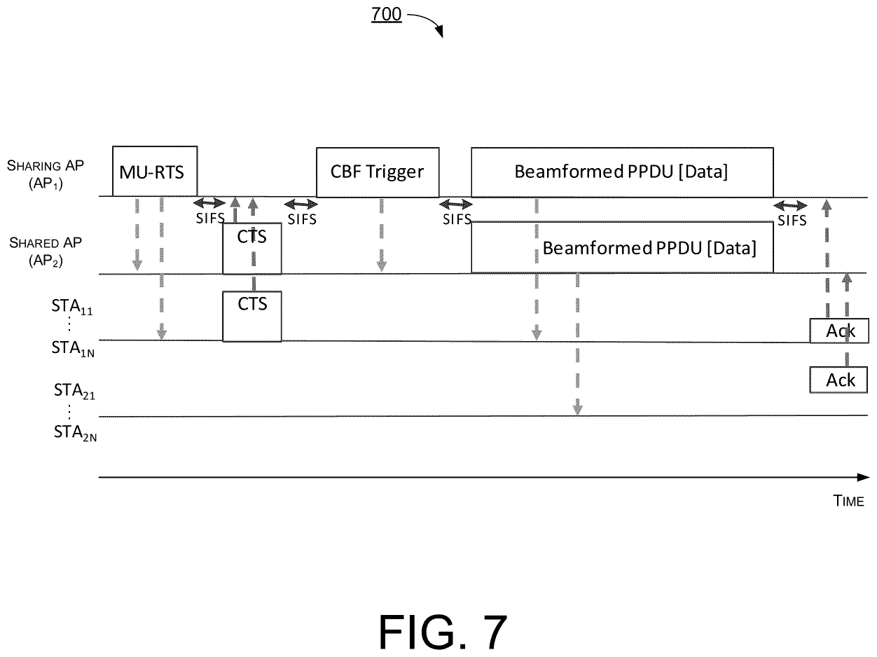

FIG. 7 illustrates an example scenario 700 under a proposed scheme of multi-AP coordinated beamforming in accordance with the present disclosure. Under the proposed scheme, after the frame exchange described above with respect to FIG. 6, each of the STAs associated with the sharing AP, STA₁₁~STA_{1N}, and each of the STAs associated with the shared AP, STA₂₁~STA_{2N}, may transmit a corresponding acknowledgement (ACK) frame to the sharing AP and the shared AP, respectively, in response to receiving the respective beamformed PPDU carrying a respective data frame. The sharing AP may indicate an UL resource unit (RU) allocation for a control response (e.g., the ACK frame) in the second control frame.

### Illustrative Implementations

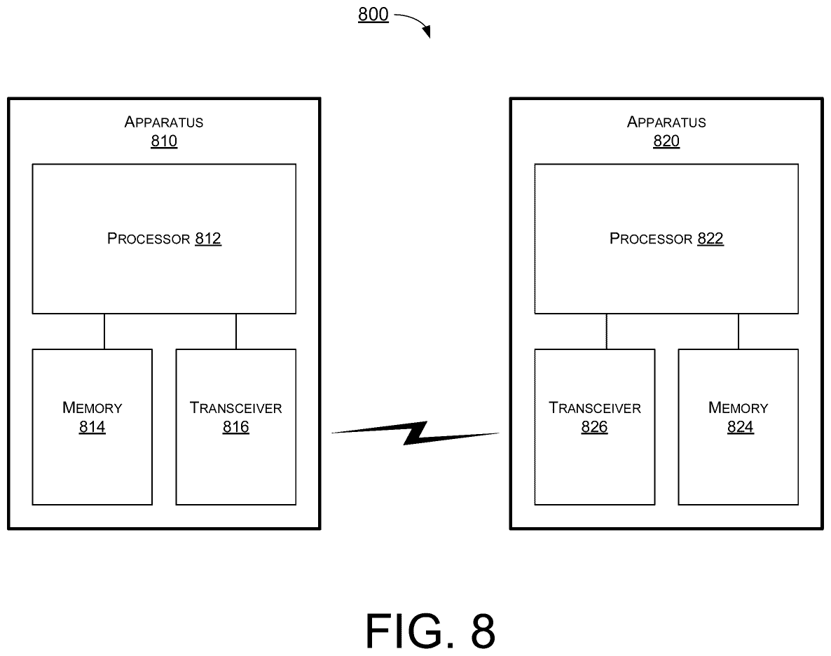

FIG. 8 illustrates an example system 800 having at least an example apparatus 810 and an example apparatus 820 in accordance with an implementation of the present disclosure. Each of apparatus 810 and apparatus 820 may perform various functions to implement schemes, techniques, processes and methods described herein pertaining to multi-AP coordinated beamforming in wireless communications, including the various schemes described above with respect to various proposed designs, concepts, schemes, systems and methods described above as well as processes described below. For instance, apparatus 810 may be an example implementation of a sharing AP (e.g., AP₁), and apparatus 820 may be an example implementation of a shared AP (e.g., AP₂) or an associated STA (e.g., one of STA₁₁~STA_{1N}).

Each of apparatus 810 and apparatus 820 may be a part of an electronic apparatus, which may be a STA or an AP, such as a portable or mobile apparatus, a wearable apparatus, a wireless communication apparatus or a computing apparatus. For instance, each of apparatus 810 and apparatus 820 may be implemented in a smartphone, a smart watch, a personal digital assistant, a digital camera, or a computing equipment such as a tablet computer, a laptop computer or a notebook computer. Each of apparatus 810 and apparatus 820 may also be a part of a machine type apparatus, which may be an IoT apparatus such as an immobile or a stationary apparatus, a home apparatus, a wire communication apparatus or a computing apparatus. For instance, each of apparatus 810 and apparatus 820 may be implemented in a smart thermostat, a smart fridge, a smart door lock, a wireless speaker or a home control center. When implemented in or as a network apparatus, apparatus 810 and/or apparatus 820 may be implemented in a network node, such as an AP in a WLAN.

In some implementations, each of apparatus 810 and apparatus 820 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 810 and apparatus 820 may be implemented in or as a STA or an AP. Each of apparatus 810 and apparatus 820 may include at least some of those components shown in FIG. 8 such as a processor 812 and a processor 822, respectively, for example. Each of apparatus 810 and apparatus 820 may further include one or more other components not pertinent to the proposed scheme of the present disclosure (e.g., internal power supply, display device and/or user interface device), and, thus, such component(s) of apparatus 810 and apparatus 820 are neither shown in FIG. 8 nor described below

In one aspect, each of processor 812 and processor 822 may be implemented in the form of one or more single-core processors, one or more multi-core processors, one or more RISC processors or one or more CISC processors. That is, even though a singular term “a processor” is used herein to refer to processor 812 and processor 822, each of processor 812 and processor 822 may include multiple processors in some implementations and a single processor in other implementations in accordance with the present disclosure. In another aspect, each of processor 812 and processor 822 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 812 and processor 822 is a special-purpose machine specifically designed, arranged and configured to perform specific tasks including those pertaining to multi-AP coordinated beamforming in wireless communications in accordance with various implementations of the present disclosure. For instance, each of processor 812 and processor 822 may be configured with hardware components, or circuitry, implementing one, some or all of the examples described and illustrated herein.

In some implementations, apparatus 810 may also include a transceiver 816 coupled to processor 812. Transceiver 816 may be capable of wirelessly transmitting and receiving data. In some implementations, apparatus 820 may also include a transceiver 826 coupled to processor 822. Transceiver 826 may include a transceiver capable of wirelessly transmitting and receiving data.

In some implementations, apparatus 810 may further include a memory 814 coupled to processor 812 and capable of being accessed by processor 812 and storing data therein. In some implementations, apparatus 820 may further include a memory 824 coupled to processor 822 and capable of being accessed by processor 822 and storing data therein. Each of memory 814 and memory 824 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 814 and memory 824 may include a type of read-only memory (ROM) such as mask ROM, programmable ROM (PROM), erasable programmable ROM (EPROM) and/or electrically erasable programmable ROM (EEPROM). Alternatively, or additionally, each of memory 814 and memory 824 may include a type of non-volatile random-access memory (NVRAM) such as flash memory, solid-state memory, ferroelectric RAM (FeRAM), magnetoresistive RAM (MRAM) and/or phase-change memory.

Each of apparatus 810 and apparatus 820 may be a communication entity capable of communicating with each other using various proposed schemes in accordance with the present disclosure. For illustrative purposes and without limitation, a description of capabilities of apparatus 810, as a sharing AP (e.g., AP₁), and apparatus 820, as a shared AP (e.g., AP₂), is provided below in the context of example processes 900 and 1000. It is noteworthy that, although the example implementations described below are provided in the context of WLAN, the same may be implemented in other types of networks. Thus, although the following description of example implementations pertains to a scenario in which apparatus 810 functions as a transmitting device and apparatus 820 functions as a receiving device, the same is also applicable to another scenario in which apparatus 810 functions as a receiving device and apparatus 820 functions as a transmitting device.

### Illustrative Processes

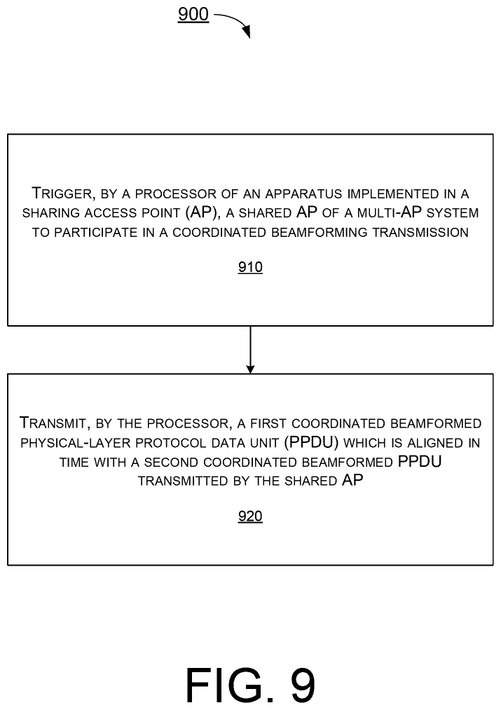

FIG. 9 illustrates an example process 900 in accordance with an implementation of the present disclosure. Process 900 may represent an aspect of implementing various proposed designs, concepts, schemes, systems and methods described above. More specifically, process 900 may represent an aspect of the proposed concepts and schemes pertaining to multi-AP coordinated beamforming in wireless communications in accordance with the present disclosure. Process 900 may include one or more operations, actions, or functions as illustrated by one or more of blocks 910 and 920. Although illustrated as discrete blocks, various blocks of process 900 may be divided into additional blocks, combined into fewer blocks, or eliminated, depending on the desired implementation. Moreover, the blocks/sub-blocks of process 900 may be executed in the order shown in FIG. 9 or, alternatively, in a different order. Furthermore, one or more of the blocks/sub-blocks of process 900 may be executed repeatedly or iteratively. Process 900 may be implemented by or in apparatus 810 and apparatus 820 as well as any variations thereof. Solely for illustrative purposes and without limiting the scope, process 900 is described below in the context of apparatus 810 as a sharing AP (e.g., AP₁) and apparatus 820 as a shared AP (e.g., AP₂) of a wireless network such as a multi-AP system in a WLAN in accordance with one or more of IEEE 802.11 standards. Process 900 may begin at block 910.

At 910, process 900 may involve processor 812 of apparatus 810 triggering, via transceiver 816, a shared AP (e.g., apparatus 820) of a multi-AP system to participate in a coordinated beamforming transmission. Process 900 may proceed from 910 to 920.

At 920, process 900 may involve processor 812 transmitting, via transceiver 816, a first coordinated beamformed PPDU which is aligned in time with a second coordinated beamformed PPDU transmitted by the shared AP.

In some implementations, in triggering, process 900 may involve processor 812 performing certain operations. For instance, process 900 may involve processor 812 transmitting a first control frame (e.g., MU-RTS) to the shared AP and one or more STAs associated with the sharing AP. Additionally, process 900 may involve processor 812 receiving a respective response frame (e.g., CTS) from each of the shared AP and the one or more STAs. Moreover, process 900 may involve a second control frame (e.g., CBF trigger frame) to the shared AP. In some implementations, the second control frame may indicate that the shared AP is allowed to transmit the second coordinated beamformed PPDU a SIFS after the second control frame. Alternatively, or additionally, the second control frame may contain information of the shared AP, a DL transmission time and an UL transmission time. Alternatively, or additionally, the second control frame may indicate an UL RU allocation time for transmission of a control response by each of one or more STAs associated with the sharing AP and the shared AP.

In some implementations, in triggering, process 900 may optionally involve processor 812 performing certain operations. For instance, process 900 may involve processor 812 transmitting a first control frame (e.g., MU-RTS) to the shared AP and one or more STAs associated with the sharing AP. Additionally, process 900 may involve processor 812 receiving a respective response frame (e.g., CTS) from each of the shared AP and the one or more STAs. Moreover, process 900 may involve processor 812 transmitting a second control frame (e.g., multi-AP BSR trigger frame) to the shared AP. Furthermore process 900 may involve processor 812 receiving a second response frame (e.g., multi-AP BSR) from the shared AP. In some implementations, the second response frame may contain a respective list of candidate STAs among a set of STAs associated with the shared AP.

In some implementations, the first coordinated beamformed PPDU may carry a first data frame for one or more first STAs associated with the sharing AP, and the second coordinated beamformed PPDU may carry a second data frame for one or more second STAs associated with the shared AP.

In some implementations, process 900 may further involve processor 812 receiving, via transceiver 816, an ACK from each of one or more first STAs associated with the sharing AP (while apparatus 820, as a shared AP, may receive an ACK from each of one or more second STAs associated with the shared AP). In such cases, the first coordinated beamformed PPDU may be transmitted to the one or more first STAs associated with the sharing AP, while the second coordinated beamformed PPDU may be transmitted to one or more second STAs associated with the shared AP.

FIG. 10 illustrates an example process 1000 in accordance with an implementation of the present disclosure. Process 1000 may represent an aspect of implementing various proposed designs, concepts, schemes, systems and methods described above. More specifically, process 1000 may represent an aspect of the proposed concepts and schemes pertaining to multi-AP coordinated beamforming in wireless communications in accordance with the present disclosure. Process 1000 may include one or more operations, actions, or functions as illustrated by one or more of blocks 1010 and 1020. Although illustrated as discrete blocks, various blocks of process 1000 may be divided into additional blocks, combined into fewer blocks, or eliminated, depending on the desired implementation. Moreover, the blocks/sub-blocks of process 1000 may be executed in the order shown in FIG. 10 or, alternatively, in a different order. Furthermore, one or more of the blocks/sub-blocks of process 1000 may be executed repeatedly or iteratively. Process 1000 may be implemented by or in apparatus 810 and apparatus 820 as well as any variations thereof. Solely for illustrative purposes and without limiting the scope, process 1000 is described below in the context of apparatus 810 as a sharing AP (e.g., AP₁) and apparatus 820 as a shared AP (e.g., AP₂) of a wireless network such as a multi-AP system in a WLAN in accordance with one or more of IEEE 802.11 standards. Process 1000 may begin at block 1010.

At 1010, process 1000 may involve processor 822 of apparatus 820 receiving, via transceiver 826, a trigger from a sharing AP (e.g., apparatus 810) of a multi-AP system that triggering the shared AP to participate in a coordinated beamforming transmission. Process 1000 may proceed from 1010 to 1020.

At 1020, process 1000 may involve processor 822, responsive to receiving the trigger, transmitting, via transceiver 826, a second coordinated beamformed PPDU which is aligned in time with a first coordinated beamformed PPDU transmitted by the sharing AP.

In some implementations, in receiving the trigger, process 1000 may involve processor 822 performing certain operations. For instance, process 1000 may involve processor 822 receiving a first control frame (e.g., MU-RTS) from the sharing AP. Additionally, process 1000 may involve processor 822 transmitting a response frame (e.g., CTS) to the sharing AP responsive to receiving the first control frame. Moreover, process 1000 may involve processor 822 receiving a second control frame (e.g., CBF trigger frame) from the sharing AP. In some implementations, the second control frame may indicate that the shared AP is allowed to transmit the second coordinated beamformed PPDU a SIFS after the second control frame. Alternatively, or additionally, the second control frame may contain information of the shared AP, a DL transmission time and an UL transmission time. Alternatively, or additionally, the second control frame may indicate an UL RU allocation time for transmission of a control response by each of one or more STAs associated with the sharing AP and the shared AP.

In some implementations, in receiving the trigger, process 1000 may optionally involve processor 822 performing certain operations. For instance, process 1000 may involve processor 822 receiving a first control frame (e.g., MU-RTS) from the sharing AP. Additionally, process 1000 may involve processor 822 transmitting a response frame (e.g., CTS) to the sharing AP responsive to receiving the MU-RTS. Moreover, process 1000 may involve processor 822 receiving a second control frame (e.g., multi-AP BSR trigger frame) from the sharing AP. Furthermore, process 1000 may involve processor 822 transmitting a second response frame (e.g., multi-AP BSR) to the sharing AP. In some implementations, the second response frame may contain a list of candidate STAs among a set of STAs associated with the shared AP.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
triggering, by a processor of an apparatus implemented in a sharing access point (AP), a shared AP of a multi-AP system to participate in a coordinated beamforming transmission; and
transmitting, by the processor, a first coordinated beamformed physical-layer protocol data unit (PPDU) which is aligned in time with a second coordinated beamformed PPDU transmitted by the shared AP.

2. The method of claim 1, wherein the triggering comprises:
transmitting a first control frame to the shared AP and one or more stations (STAs) associated with the sharing AP;
receiving a respective response frame from each of the shared AP and the one or more STAs; and
transmitting a second control frame to the shared AP.

3. The method of claim 2, wherein the second control frame indicates that the shared AP is allowed to transmit the second coordinated beamformed PPDU a short interframe space (SIFS) after the second control frame.

4. The method of claim 2, wherein the second control frame contains information of the shared AP, a downlink (DL) transmission time and an uplink (UL) transmission time.

5. The method of claim 2, wherein the second control frame indicates an uplink (UL) resource unit (RU) allocation time for transmission of a control response by each of one or more stations (STAs) associated with the sharing AP and the shared AP.

6. The method of claim 1, wherein the triggering comprises:
transmitting a first control frame to the shared AP and one or more stations (STAs) associated with the sharing AP;
receiving a respective response frame from each of the shared AP and the one or more STAs;
transmitting a second control frame to the shared AP; and
receiving a second response frame from the shared AP.

7. The method of claim 6, wherein the second control frame contains a respective list of candidate STAs among a set of STAs associated with the shared AP.

8. The method of claim 1, wherein the first coordinated beamformed PPDU carries a first data frame for one or more first stations (STAs) associated with the sharing AP, and wherein the second coordinated beamformed PPDU carries a second data frame for one or more second STAs associated with the shared AP.

9. The method of claim 1, further comprising:
receiving, by the processor, an acknowledgement (ACK) from each of one or more first stations (STAs) associated with the sharing AP,
wherein the first coordinated beamformed PPDU is transmitted to the one or more first STAs associated with the sharing AP, and
wherein the second coordinated beamformed PPDU is transmitted to one or more second STAs associated with the shared AP.

10. A method, comprising:
receiving, by a processor of an apparatus implemented in a shared access point (AP), a trigger from a sharing AP of a multi-AP system that triggering the shared AP to participate in a coordinated beamforming transmission; and
transmitting, by the processor responsive to receiving the trigger, a second coordinated beamformed physical-layer protocol data unit (PPDU) which is aligned in time with a first coordinated beamformed PPDU transmitted by the sharing AP.

11. The method of claim 10, wherein the receiving of the trigger comprises:
receiving a first control frame from the sharing AP;
transmitting a response frame to the sharing AP responsive to receiving the first control frame; and
receiving a second control frame from the sharing AP.

12. The method of claim 11, wherein the second control frame indicates that the shared AP is allowed to transmit the second coordinated beamformed PPDU a short interframe space (SIFS) after the second control frame.

13. The method of claim 11, wherein the second control frame contains information of the shared AP, a downlink (DL) transmission time and an uplink (UL) transmission time.

14. The method of claim 11, wherein the second control frame indicates an uplink (UL) resource unit (RU) allocation time for transmission of a control response by each of one or more stations (STAs) associated with the sharing AP and the shared AP.

15. The method of claim 10, wherein the receiving of the trigger comprises:
receiving a first control frame from the sharing AP;
transmitting a response frame to the sharing AP responsive to receiving the first control frame; and
receiving a second control frame from the sharing AP; and
transmitting a second response frame to the sharing AP.

16. The method of claim 15, wherein the second response frame contains a list of candidate STAs among a set of STAs associated with the shared AP.

17. An apparatus implementable in a sharing access point (AP) of a multi-AP system, comprising:
a transceiver configured to transmit and receive wirelessly; and
a processor coupled to the transceiver and configured to perform operations comprising:
triggering, via the transceiver, a shared AP of the multi-AP system to participate in a coordinated beamforming transmission; and
transmitting, via the transceiver, a first coordinated beamformed physical-layer protocol data unit (PPDU) which is aligned in time with a second coordinated beamformed PPDU transmitted by the shared AP.

18. The apparatus of claim 17, wherein the triggering comprises:
transmitting a first control frame to the shared AP and one or more stations (STAs) associated with the sharing AP;
receiving a respective response frame from each of the shared AP and the one or more STAs; and
transmitting a second control frame to the shared AP.

19. The apparatus of claim 18, wherein the second control frame indicates that the shared AP is allowed to transmit the second coordinated beamformed PPDU a short interframe space (SIFS) after the second control frame.

20. The apparatus of claim 18, wherein the second control frame contains information of the shared AP, a downlink (DL) transmission time and an uplink (UL) transmission time, and wherein the second control frame also indicates an uplink (UL) resource unit (RU) allocation time for transmission of a control response by each of one or more stations (STAs) associated with the sharing AP and the shared AP.
